(19) United States
(12) Patent Application Publication
(10) Pub. No.: US 2025/0128820 A1
(43) Pub. Date: Apr. 24, 2025

(54) EQUIPMENT CABINET FOR USE IN EJECTION SEAT RAILS

(71) Applicant: Rockwell Collins, Inc., Cedar Rapids, IA (US)

(72) Inventor: Dustin J. Wimmer, Colorado Springs, CO (US)

(73) Assignee: Rockwell Collins, Inc., Cedar Rapids, IA (US)

(21) Appl. No.: 18/894,317

(22) Filed: Sep. 24, 2024

Related U.S. Application Data
(60) Provisional application No. 63/591,689, filed on Oct. 19, 2023.

(51) Int. Cl. B64D 25/10; A47C 31/00

(52) U.S. Cl. CPC B64D 25/10; A47C 31/00

(57) ABSTRACT

An equipment cabinet for an aircraft cockpit or aircraft test cockpit is provided. The equipment cabinet includes at least one of a plurality of sliders or a plurality of rollers coupled to the equipment cabinet. The at least one of the plurality of sliders or the plurality of rollers are configured to engage with at least one rail assembly of a removed ejection seat. The at least one rail assembly defining a channel configured to receive the at least one of the plurality of sliders or the plurality of rollers.

### CROSS-REFERENCE TO RELATED APPLICATIONS

This application claims priority to, U.S. Provisional Application No. 63/591,689, filed Oct. 19, 2023, and entitled “EQUIPMENT CABINET FOR USE IN EJECTION SEAT RAILS,” which is incorporated by reference herein in its entirety for all purposes.

### FIELD

The present disclosure relates to ejection seats and, more specifically, to ejection seat rail assemblies.

### BACKGROUND

Certain aircraft cockpits or aircraft test cockpits may include ejection systems designed to eject a member of the flight crew from the cockpit in certain situations. These ejection systems typically include one or more ejection seats in which one or members of the flight crew are located during flight and which may be ejected from the cockpit in case of emergency. These ejection seats typically includes sliders or rollers attached to the sides of the seat structure. The sliders or rollers are generally located in a rail (or roller track) which may be affixed to a stationary structure in the cockpit. The sliders or rollers translate along the rail to help guide the ejection seat during ejection.

### SUMMARY

An equipment cabinet for an aircraft cockpit or aircraft test cockpit is disclosed herein. The equipment cabinet includes at least one of a plurality of sliders or a plurality of rollers coupled to the equipment cabinet. The at least one of the plurality of sliders or the plurality of rollers are configured to engage with at least one rail assembly of a removed ejection seat, the at least one rail assembly defining a channel configured to receive the at least one of the plurality of sliders or the plurality of rollers.

In various embodiments, the equipment cabinet further includes a cross-support beam configured to receive at least one actuator associated with the removed ejection seat, in various embodiments, the at least one actuator is configured to couple to the cross-support beam thereby restraining the equipment cabinet in place.

In various embodiments, the at least one actuator is coupled to the cross-support beam utilizing a retention mechanism.

In various embodiments, the equipment cabinet further includes an actuator access area configured to provide for the at least one actuator to translate into the cross-support beam.

In various embodiments, the equipment cabinet further includes an actuator access panel configured to seal off the actuator access area.

In various embodiments, the equipment cabinet further includes a set of hoist points configured to assist in lifting the equipment cabinet for at least one of installing or removing the equipment cabinet.

In various embodiments, the equipment cabinet further includes a set of floor bumpers configured to contact a floor so that the equipment cabinet rests on the floor.

In various embodiments, the equipment cabinet further includes a set of removable covers. In various embodiments, each removable cover of the set of removable covers is configured to cover an exterior portion of the equipment cabinet and provide accessibility to equipment housed within the equipment cabinet. In various embodiments, each removable cover of the set of removable covers utilizes a compression seal configured to seal around a perimeter of an area which the removable cover covers.

In various embodiments, the equipment cabinet further includes a vent within one or more of the set of removable covers and configured to provide air flow and cooling to equipment housed within the equipment cabinet.

In various embodiments, the equipment cabinet further includes at least one knockout configured for at least one of a power cable or a communication cable to run through.

Also disclosed herein is an aircraft cockpit or aircraft test cockpit. The aircraft cockpit or aircraft test cockpit includes at least one ejection seat area, an equipment cabinet configured to fit within the at least one ejection seat area, and at least one of a plurality of sliders or a plurality of rollers coupled to the equipment cabinet. In various embodiments, the at least one of the plurality of sliders or the plurality of rollers are configured to engage with at least one rail assembly of a removed ejection seat in the at least one ejection seat area, the at least one rail assembly defining a channel configured to receive the at least one of the plurality of sliders or the plurality of rollers.

In various embodiments, the equipment cabinet further includes a cross-support beam configured to receive at least one actuator associated with the removed ejection seat. In various embodiments, the at least one actuator is configured to couple to the cross-support beam thereby restraining the equipment cabinet in place.

In various embodiments, the at least one actuator is coupled to the cross-support beam utilizing a retention mechanism.

In various embodiments, the equipment cabinet further includes an actuator access area configured to provide for the at least one actuator to translate into the cross-support beam.

In various embodiments, the equipment cabinet further includes an actuator access panel configured to seal off the actuator access area.

In various embodiments, the equipment cabinet further includes a set of hoist points configured to assist in lifting the equipment cabinet for at least one of installing or removing the equipment cabinet.

In various embodiments, the equipment cabinet further includes a set of floor bumpers configured to contact a floor so that the equipment cabinet rests on the floor.

In various embodiments, the equipment cabinet further includes a set of removable covers. In various embodiments, each removable cover of the set of removable covers is configured to cover an exterior portion of the equipment cabinet and provide accessibility to equipment housed within the equipment cabinet. In various embodiments, each removable cover of the set of removable covers utilizes a compression seal configured to seal around a perimeter of an area which the removable cover covers.

In various embodiments, the equipment cabinet further includes a vent within one or more of the set of removable covers and configured to provide air flow and cooling to equipment housed within the equipment cabinet.

In various embodiments, the equipment cabinet further includes at least one knockout configured for at least one of a power cable or a communication cable to run through.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1A illustrates an ejection seat being launched from an aircraft cockpit or aircraft test cockpit, in accordance with various embodiments.

FIG. 1B illustrates an ejection seat and rail assembly, in accordance with various embodiments.

FIG. 1C illustrates an ejection seat and rail assembly, in accordance with various embodiments.

FIGS. 2A and 2B illustrates an exterior view of an equipment cabinet configured to be secured to a set of ejection seat rails, in accordance with various embodiments.

FIG. 3 illustrates an interior view of an equipment cabinet configured to be secured to a set of ejection seat rails, in accordance with various embodiments.

FIGS. 4A, 4B, 4C, 4D, 4E, and 4F illustrate a method of installing an equipment cabinet, in accordance with various embodiments.

FIG. 5 illustrates an equipment cabinet installed onto rails utilized for an ejection seat, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to tacked, attached, fixed, coupled, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts but not necessarily to denote the same or different materials.

As stated previously, certain aircraft or aircraft test cockpits may include ejection systems designed to eject a member of the flight crew from the aircraft cockpit or aircraft test cockpit in certain situations. These ejection systems typically include one or more ejection seats in which one or members of the flight crew are located during flight and which may be ejected from the aircraft cockpit or aircraft test cockpit in case of emergency. These ejection seats typically includes sliders or rollers attached to the sides of the seat structure. The sliders or rollers are generally located in a rail (or roller track) which may be affixed to a stationary structure in the cockpit. The sliders or rollers translate along the rail to help guide the ejection seat during ejection. On certain aircraft or aircraft test cockpits that have multiple ejection seats, only one pilot may fly some missions. During such missions, a variety of equipment may be necessary that may fit in a space where a second ejection seat would be located.

Disclosed herein is an equipment cabinet that may be used to house the variety of equipment when only one pilot is flying a mission. In various embodiments, the equipment cabinet utilizes rollers, such as the sliders or rollers utilized for an ejection seat, such that the sliders or rollers may couple to the existing rails utilized for an ejection seat in an aircraft cockpit or aircraft test cockpit. In that regard, in various embodiments, the equipment cabinet may conform to fit within a same space as that would be occupied by an ejection seat. Accordingly, only one pilot is flying a mission, the second ejection seat in an aircraft cockpit or aircraft test cockpit may be removed and replaced by the equipment cabinet described hereafter, the equipment cabinet configured to house a variety of equipment necessary for the mission. In that regard, in various embodiments, the equipment cabinet may be configured with a set of hoist points to assist in lifting the equipment cabinet for installing or removing the equipment cabinet into or out of the aircraft cockpit or aircraft test cockpit. In various embodiments, the set of hoist points may be constructed from stainless steel, carbon steel, or steel, among others. In various embodiments, the equipment cabinet may be configured with a set of floor bumpers for the equipment cabinet to rest on the floor of the aircraft cockpit or aircraft test cockpit. In various embodiments, the equipment cabinet may be configured with a set of sliders or rollers configured to mechanically operate with the existing rails utilized for the ejection seat. In various embodiments, the equipment cabinet may be configured with a set of removable covers that cover one or more of the exterior portions of the equipment cabinet and provide for accessibility to equipment housed within the equipment cabinet. In various embodiments, each removable cover of the set of removable covers may utilize a compression seal configured to seal around a perimeter of the area which the removable cover covers. In various embodiments, each removable cover of the set of removable covers may be formed by a metal or a composite material, among others. In various embodiments, the equipment cabinet may be configured with one or more vents within one or more of the removable covers so as to provide air flow and cooling to the equipment housed within the equipment cabinet. In various embodiments, the equipment cabinet may be configured with a set of shelves in an interior of the equipment cabinet. In various embodiments, each shelve of the set of shelves is configured to support one or more pieces of equipment. In various embodiments, the equipment cabinet may be configured with a mounting frames configured for mounting the equipment within the equipment rack. In various embodiments, the equipment cabinet may be configured such that the set of shelves provide a clearance so that power cables or communication cables, among others, may be run between various equipment. In various embodiments, the equipment cabinet may be configured with electrical and/or communication knockouts so that power cables or communication cables, among others, may be run between various equipment and the aircraft cockpit or aircraft test cockpit.

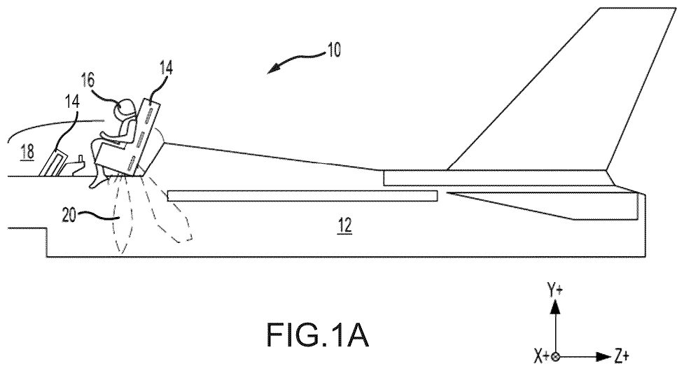

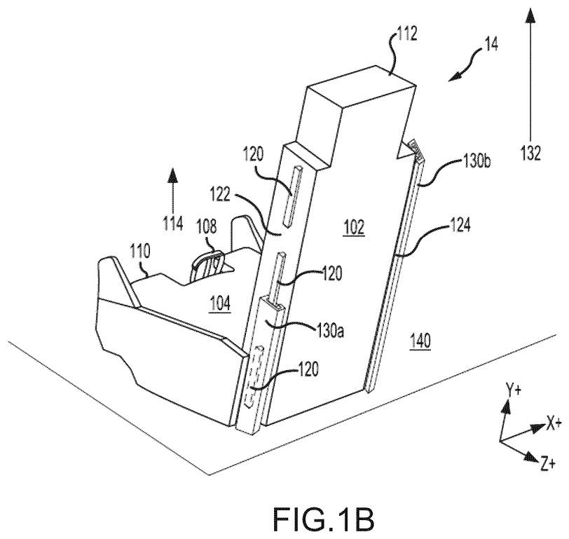

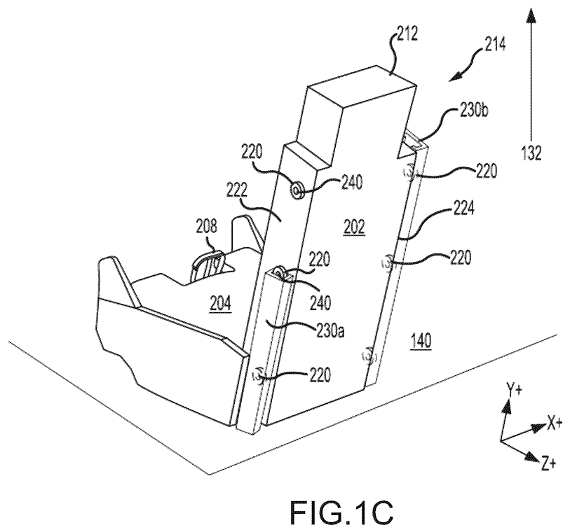

With reference to FIG. 1A, an aircraft ejection system 10 is shown. In accordance with various embodiments, aircraft ejection system 10 may be installed in an aircraft or aircraft test cockpit 12 to expel one or more of ejection seats 14 and an occupant 16 of the respective ejection seat 14 from a cockpit 18 of aircraft or aircraft test cockpit 12. Each ejection seat 14 may be urged from cockpit 18 by a propulsion system 20. While aircraft or aircraft test cockpit 12 and aircraft ejection system 10 are illustrated having a single ejection seat 14, it is contemplated and understood that aircraft or aircraft test cockpit 12 may include multiple ejection seats, which may be expelled via aircraft ejection system 10 or their own respective aircraft ejection system.

With reference to FIG. 1B, and continuing reference to FIG. 1A, an ejection seat of the one or more ejection seats 14 of the aircraft ejection system 10 is illustrated. Ejection seat 14 includes a seatback 102 and a seat pan 104. Seat pan 104 supports the bulk of the weight of the occupant 16. In various embodiments, an ejection handle 108 may be located proximate a frontside 110 of seat pan 104. Frontside 110 of seat pan 104 is generally opposite, or distal, seatback 102. While FIG. 1B illustrates ejection handle 108 located at frontside 110 of seat pan 104, it is further contemplated and understood that ejection handle 108 may be located anywhere that is accessible to an occupant of ejection seat 14. For example, ejection handle 108 may be located proximate a headrest 112 of ejection seat 14 or in other locations in cockpit 18. Ejection handle 108 may be configured to initiate an ejection sequence upon actuation. For example, occupant 16 (FIG. 1A) pulling the ejection handle 108 in the direction of arrow 114 may initiate the ejection sequence that expels ejection seat 14 from the cockpit 18 of the aircraft or aircraft test cockpit 12.

In various embodiments, ejection seat 14 includes a plurality of sliders 120. Sliders 120 are coupled to opposing sides of ejection seat 14. In various embodiments, a left (or first) rail assembly 130a and a right (or second) rail assembly 130b (collectively referred to as rail assemblies 130) are located proximate left side 122 and right side 124, respectively, of ejection seat 14. In FIG. 1B, the upper portion of the left rail assembly 130a has been removed to illustrate sliders 120. Rail assemblies 130 are configured to receive sliders 120. In this regard, the sliders 120 located along left side 122 may be located in left rail assembly 130a and the sliders 120 located along right side 124 may be located in right rail assembly 130b. Rail assemblies 130 are stationary structures which remain in cockpit 18 during expulsion of ejection seat 14. The coupling between sliders 120 and ejection seat 14 causes sliders 120 to translate with ejection seat 14 during ejection. During ejection, sliders 120 will translate, or slide, within channels defined by their respective rail assemblies 130. Rail assemblies 130 are configured to restrict sliders 120 from moving in the forward and aft directions (i.e., along the Z-axis) and/or in the left and right direction (i.e., along the X-axis), thereby helping to guide the sliders 120 and ejection seat 14 out of cockpit 18 and in the direction of arrow 132 (i.e. in the positive direction on the Y-axis). As described in further detail below, rail assemblies 130 may each include a rail insert. Sliders 120 may be formed of any suitable material that will reduce friction relative to the rail and/or to the rail insert. In various embodiments, sliders 120 may be formed of steel or other suitable low coefficient of friction material. For example, in various embodiments, the material of sliders 120 is selected such that the kinetic coefficient of friction for the sliders 120 on the rail insert is less than 0.75. In various embodiments, the kinetic coefficient of friction for the sliders 120 on the rail insert may be less than 0.50. Forming the sliders 120 using steel or other low coefficient of friction material tends to reduce occurrences of binding between sliders 120 and the rail inserts.

With reference to FIG. 1C, an ejection seat 214 is illustrated. In various embodiments, the aircraft ejection system 10, with momentary reference to FIG. 1A, may include ejection seat 214 in place of, or in addition to, ejection seat 14. Ejection seat 214 includes a seatback 202, a seat pan 204, and an ejection handle 208, similar to ejection seat 14 in FIG. 1B. In accordance with various embodiments, ejection seat 214 includes a plurality of rollers 220. Rollers 220 are coupled to opposing sides of ejection seat 214. For example, a plurality of first rollers 220 may be located along a left (or first) side 222 of seatback 202 and a plurality of second rollers 220 may be located along a right (or second) side 224 of seatback 202.

In accordance with various embodiments, a left (or first) rail 230a and a right (or second) rail 230b (collectively referred to as rails 230) are located proximate left side 222 and right side 224, respectively, of ejection seat 214. In FIG. 1C, the upper portion of the left rail 230a has been removed to illustrate rollers 220. Rails 230 are configured to receive rollers 220. In this regard, the rollers 220 located along left side 222 may be located in left rail 230a and the rollers 220 located along right side 224 may be located in right rail 230b. Rails 230 are stationary structures which remain in cockpit 18 during expulsion of ejection seat 214. The coupling between rollers 220 and ejection seat 214 causes rollers 220 to translate with ejection seat 214 during ejection. During ejection, rollers 220 will translate within channels defined by their respective rail 230, while rotating (i.e., spinning) relative to seatback 202. In this regard, rollers 220 may be coupled to seatback 202 via a shaft 240. Forming the rollers 220 using steel or other low coefficient of friction material tends to reduce occurrences of binding between rollers 220 and the respective rails. Rollers 220 are configured rotate about their respective shaft 240. Rails 230 are configured to restrict rollers 220 from moving in the forward and aft directions (i.e., along the Z-axis) and/or in the left and right direction (i.e., along the X-axis), thereby helping to guide the rollers 220 and ejection seat 214 out cockpit 18 and in the direction of arrow 132 (i.e. in the positive direction on the Y-axis).

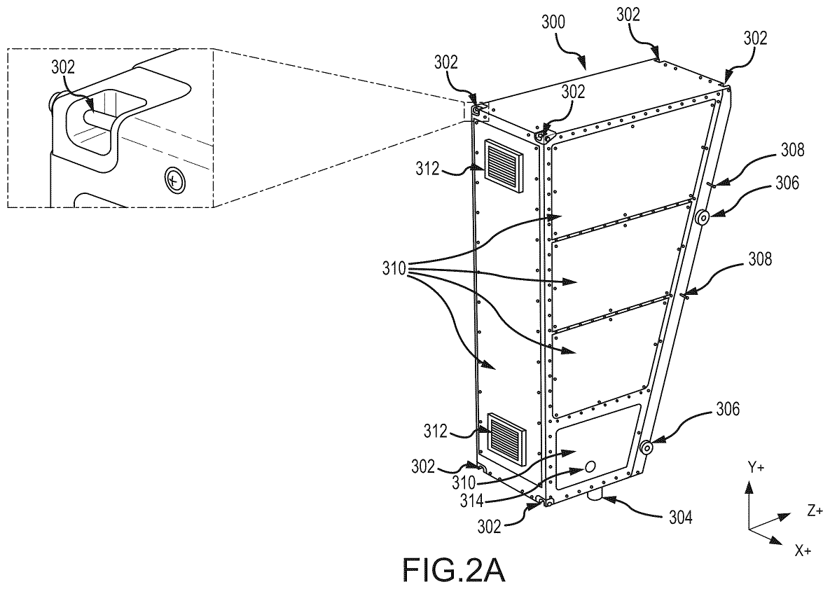

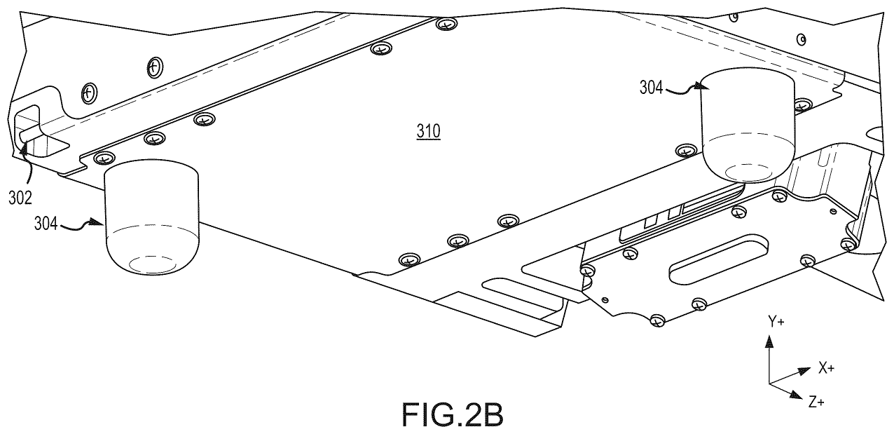

Referring now to FIGS. 2A and 2B, in accordance with various embodiments, an exterior view of an equipment cabinet 300 configured to be secured to a set of ejection seat rails is illustrated. In various embodiments, the equipment cabinet 300 may be configured with a set of hoist points 302 to assist in lifting the equipment cabinet 300, and for installing or removing the equipment cabinet 300 into or out of the aircraft cockpit or aircraft test cockpit, such as the cockpit 18 of the aircraft 12 of FIG. 1A. In various embodiments, the set of hoist points 302 may be constructed from stainless steel, carbon steel, or steel, among others. In various embodiments, the equipment cabinet 300 may be configured with a set of floor bumpers 304 configured to contact a floor of the aircraft cockpit or aircraft test cockpit so that the equipment cabinet 300 may rest on the floor of the aircraft cockpit or aircraft test cockpit. In various embodiments, the equipment cabinet 300 may be configured with a set of rollers 306 configured to mechanically operate with existing rails, such as rails 230a and 230b of FIG. 1C, utilized for the ejection seat. In various embodiments, the equipment cabinet 300 may be configured with a set of sliders configured to mechanically operate with existing rails, such as rail assembly 130a and 130b of FIG. 1B, utilized for the ejection seat. In various embodiments, the equipment cabinet 300 may be configured with one or more additional support bolts 308 configured to support the equipment cabinet 300 once installed in the existing rails.

In various embodiments, the equipment cabinet 300 may be configured with a set of removable covers 310 configured to cover one or more of the exterior portions of the equipment cabinet 300 and provide accessibility to equipment housed within the equipment cabinet 300. In various embodiments, each removable cover of the set of removable covers 310 may utilize a compression seal configured to seal around a perimeter of the area which the removable cover covers. In various embodiments, each removable cover of the set of removable covers 310 may be formed by a metal or a composite material, among others. In various embodiments, the equipment cabinet 300 may be configured with one or more vents 312 within one or more of the set of removable covers 310 or the structure of the equipment cabinet 300 itself. In various embodiments, each of the one or more vents is configured to provide air flow and cooling to the equipment housed within the equipment cabinet 300. In various embodiments, the equipment cabinet may be configured with electrical and/or communication knockouts 314 so that power cables or communication cables, among others, may be run between various equipment and the aircraft cockpit or aircraft test cockpit.

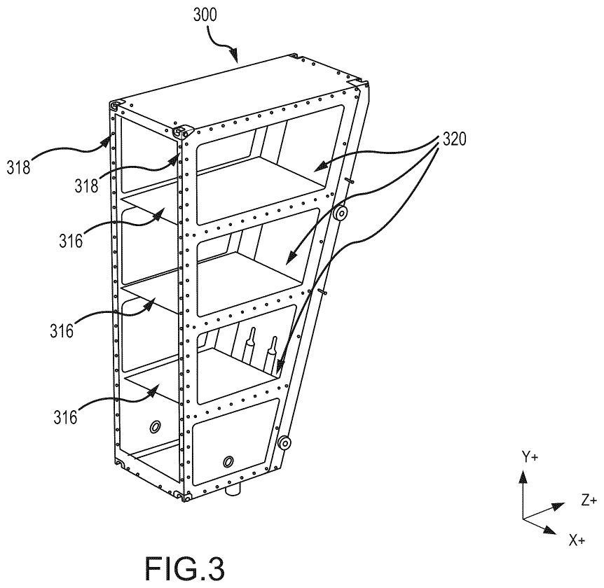

Referring now to FIG. 3, in accordance with various embodiments, an interior view of an equipment cabinet 300 configured to be secured to a set of ejection seat rails is illustrated. In various embodiments, the equipment cabinet 300 may be configured with a set of shelves 316 in an interior of the equipment cabinet 300. In various embodiments, one or more of the set of shelves 316 may be a drawer. In various embodiments, each shelve of the set of shelves 316 is configured to support one or more pieces of equipment. In various embodiments, the equipment cabinet 300 may be configured with a mounting frames 318 configured for mounting the equipment within the equipment cabinet 300. In various embodiments, the equipment cabinet may be configured such that the set of shelves provide a clearance 320 so that power cables or communication cables, among others, may be run between various equipment.

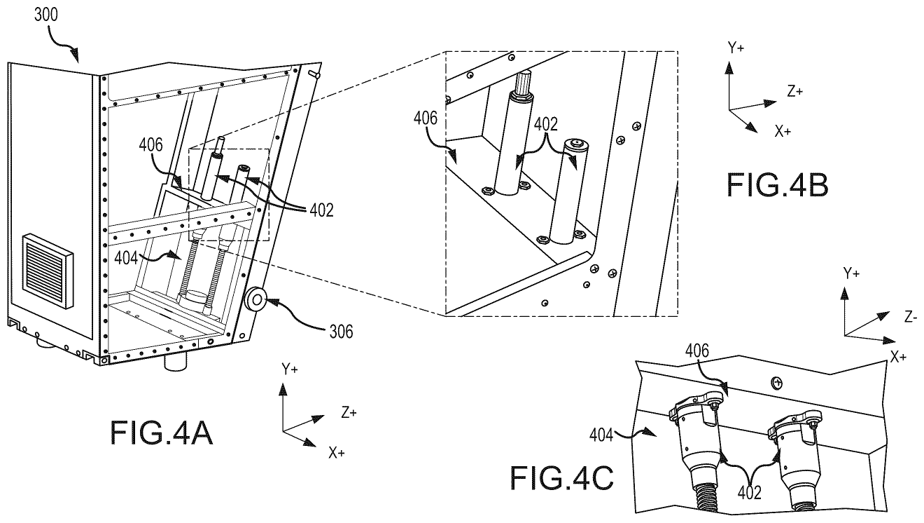

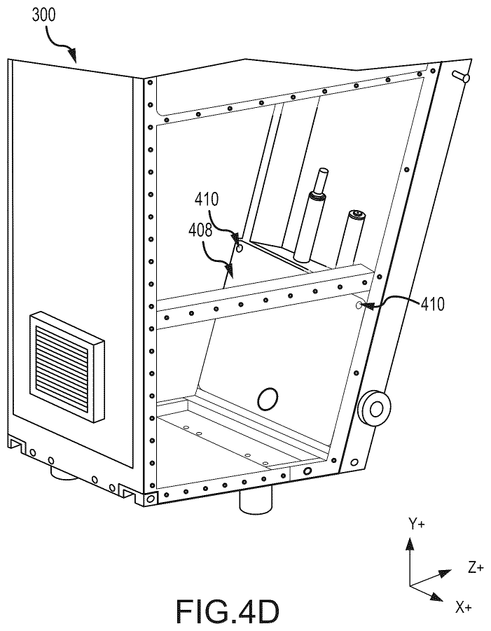

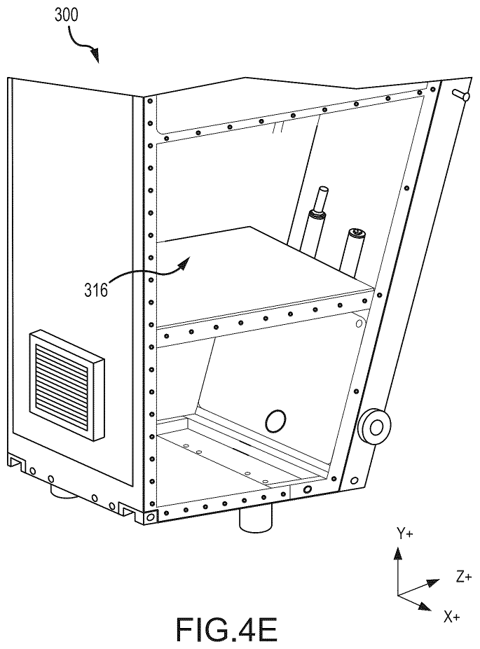

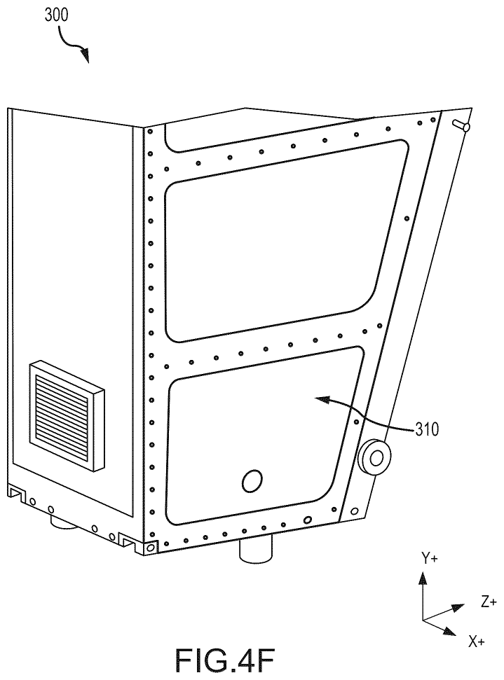

Referring now to FIGS. 4A, 4B, 4C, 4D, 4E, and 4F, in accordance with various embodiments, a method of installing an equipment cabinet 300 is illustrated. With particular attention to FIGS. 4A, 4B, an 4C, in various embodiments, when removing an ejection seat from the aircraft cockpit or aircraft test cockpit, one or more actuators 402 and a set of rails, such as rails 230a and 230b of FIG. 1C or rail assembly 130a and 130b of FIG. 1B remain. In various embodiments, in installing the equipment cabinet 300, the one or more rollers 306 or the one or more sliders are configured to engage with the set of rails. In various embodiments, the one or more actuators 402, while not utilized by the equipment cabinet 300, are configured to translate into an actuator access area 404 and coupled to a cross-support beam 406 in a rear of the equipment cabinet 300. In that regard, in order to couple the equipment cabinet 300 to the aircraft cockpit or aircraft test cockpit and so that the one or more actuators 402 are prevented from moving around during flight, the one or more actuators 402 are coupled to the cross-support beam 406 as is illustrated in FIGS. 4B and 4C utilizing a retention mechanism such as bolts and nuts, although other types of retention mechanisms are envisioned.

With particular attention to FIG. 4D, in various embodiments, once the one or more actuators 402 are coupled to the cross-support beam 406, an actuator access panel 408 is installed and coupled to an interior of the rear of the equipment cabinet 300 thereby covering a lower portion of the one or more actuators 402 and sealing the equipment cabinet 300 from the actuator access area 404. In various embodiments, the actuator access panel 408 may be coupled to the equipment cabinet 300 utilizing a set of captive fasteners 410. With particular attention to FIG. 4E, in various embodiments, once the actuator access panel 408 is in place, the set of shelves 316 are inserted. Again, in various embodiments, one or more of the set of shelves 316 may be a drawer. With particular attention to FIG. 4F, in various embodiments, once the set of shelves 316 are installed, a lower one of the set of removable covers 310 may be installed utilizing a set of captive fasteners.

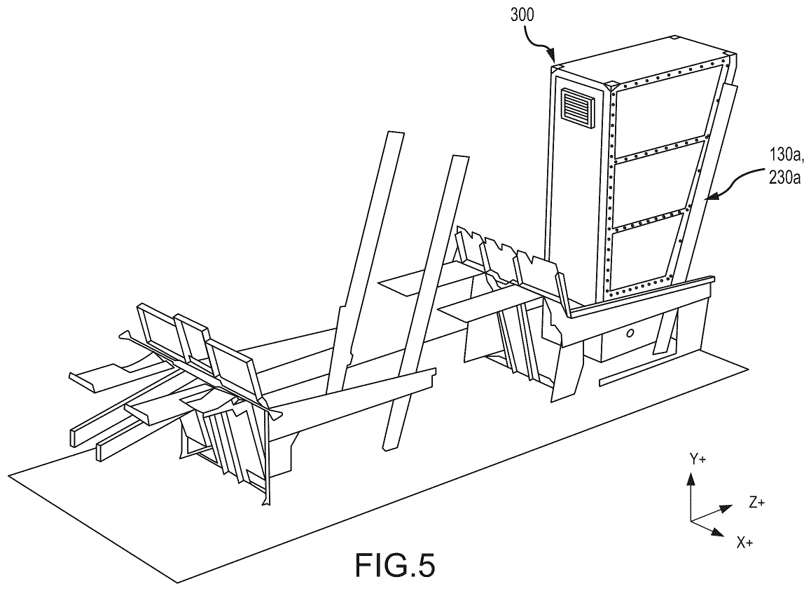

Referring now to FIG. 5, in accordance with various embodiments, an equipment cabinet 300 installed onto rails for an ejection seat is illustrated. In various embodiments, the equipment cabinet 300 described in FIGS. 2A, 2B, 3, 4A, 4B, 4C, 4D, 4E, and 4F is illustrated in an area [previous occupied by an ejection seat 14 of FIG. 1A. In various embodiments, the equipment cabinet 300 may be configured with a set of rollers 306 configured to mechanically operate with existing rails, such as rails 230a and 230b of FIG. 1C, utilized for the ejection seat. In various embodiments, the equipment cabinet 300 may be configured with a set of sliders configured to mechanically operate with existing rails, such as rail assembly 130a and 130b of FIG. 1B, utilized for the ejection seat.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An equipment cabinet for an aircraft cockpit or aircraft test cockpit, comprising:
the equipment cabinet; and
at least one of a plurality of sliders or a plurality of rollers coupled to the equipment cabinet, wherein the at least one of the plurality of sliders or the plurality of rollers are configured to engage with at least one rail assembly of a removed ejection seat, the at least one rail assembly defining a channel configured to receive the at least one of the plurality of sliders or the plurality of rollers.

2. The equipment cabinet of claim 1, further comprising:
a cross-support beam configured to receive at least one actuator associated with the removed ejection seat and wherein the at least one actuator is configured to couple to the cross-support beam thereby restraining the equipment cabinet in place.

3. The equipment cabinet of claim 2, wherein the at least one actuator is coupled to the cross-support beam utilizing a retention mechanism.

4. The equipment cabinet of claim 2, further comprising:
an actuator access area configured to provide for the at least one actuator to translate into the cross-support beam.

5. The equipment cabinet of claim 4, further comprising:
an actuator access panel configured to seal off the actuator access area.

6. The equipment cabinet of claim 1, further comprising:
a set of hoist points configured to assist in lifting the equipment cabinet for at least one of installing or removing the equipment cabinet.

7. The equipment cabinet of claim 1, further comprising:
a set of floor bumpers configured to contact a floor so that the equipment cabinet rests on the floor.

8. The equipment cabinet of claim 1, further comprising:
a set of removable covers, each removable cover of the set of removable covers configured to cover an exterior portion of the equipment cabinet and provide accessibility to equipment housed within the equipment cabinet, wherein each removable cover of the set of removable covers utilizes a compression seal configured to seal around a perimeter of an area which the removable cover covers.

9. The equipment cabinet of claim 8, further comprising:
a vent within one or more of the set of removable covers and configured to provide air flow and cooling to equipment housed within the equipment cabinet.

10. The equipment cabinet of claim 1, further comprising:
at least one knockout configured for at least one of a power cable or a communication cable to run through.

11. An aircraft cockpit or aircraft test cockpit, the aircraft cockpit or aircraft test cockpit comprising:
at least one ejection seat area;
an equipment cabinet configured to fit within the at least one ejection seat area; and
at least one of a plurality of sliders or a plurality of rollers coupled to the equipment cabinet, wherein the at least one of the plurality of sliders or the plurality of rollers are configured to engage with at least one rail assembly of a removed ejection seat in the at least one ejection seat area, the at least one rail assembly defining a channel configured to receive the at least one of the plurality of sliders or the plurality of rollers.

12. The aircraft cockpit or aircraft test cockpit of claim 11, wherein the equipment cabinet further comprises:
a cross-support beam configured to receive at least one actuator associated with the removed ejection seat and wherein the at least one actuator is configured to couple to the cross-support beam thereby restraining the equipment cabinet in place.

13. The aircraft cockpit or aircraft test cockpit of claim 12, wherein the at least one actuator is coupled to the cross-support beam utilizing a retention mechanism.

14. The aircraft cockpit or aircraft test cockpit of claim 12, wherein the equipment cabinet further comprises:
an actuator access area configured to provide for the at least one actuator to translate into the cross-support beam.

15. The aircraft cockpit or aircraft test cockpit of claim 14, wherein the equipment cabinet further comprises:
an actuator access panel configured to seal off the actuator access area.

16. The aircraft cockpit or aircraft test cockpit of claim 11, wherein the equipment cabinet further comprises:
a set of hoist points configured to assist in lifting the equipment cabinet for at least one of installing or removing the equipment cabinet.

17. The aircraft cockpit or aircraft test cockpit of claim 11, wherein the equipment cabinet further comprises:
a set of floor bumpers configured to contact a floor so that the equipment cabinet rests on the floor.

18. The aircraft cockpit or aircraft test cockpit of claim 11, wherein the equipment cabinet further comprises:
a set of removable covers, each removable cover of the set of removable covers configured to cover an exterior portion of the equipment cabinet and provide accessibility to equipment housed within the equipment cabinet, wherein each removable cover of the set of removable covers utilizes a compression seal configured to seal around a perimeter of an area which the removable cover covers.

19. The aircraft cockpit or aircraft test cockpit of claim 18, wherein the equipment cabinet further comprises:
a vent within one or more of the set of removable covers and configured to provide air flow and cooling to equipment housed within the equipment cabinet.

20. The aircraft cockpit or aircraft test cockpit of claim 11, wherein the equipment cabinet further comprises:
at least one knockout configured for at least one of a power cable or a communication cable to run through.
